(19) United States
(12) Patent Application Publication
(10) Pub. No.: US 2010/0263848 A1
(43) Pub. Date: Oct. 21, 2010

(54) Aluminum-Aluminum Nitride composite material, manufacturing method thereof and heat exchanger including the same

(75) Inventor: Yuuichi Aoki, Chita-gun (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 12/662,263

(22) Filed: Apr. 8, 2010

(30) Foreign Application Priority Data
Apr. 20, 2009 (JP) 2009-101938

(51) Int. Cl. F28F 1/00; B32B 15/04; B32B 3/10; C22B 21/00

(52) U.S. Cl. 165/177; 428/457; 428/172; 75/680

(57) ABSTRACT

Molten aluminum is heated in the range of 900° C. to 1300° C. under a nitrogen atmosphere using magnesium as an auxiliary agent to form aluminum nitride directly on the molten aluminum and bond the aluminum nitride to the aluminum so that an Al—AlN composite material is formed. Because aluminum nitride power needs not to be sintered at high temperature equal to or higher than 1900° C., the Al—AlN composite material can be formed at low temperature in the range of 900° C. to 1300° C. compared with the high temperature equal to or higher than 1900° C., and thereby the high-density aluminum nitride can be obtained.

### CROSS REFERENCE TO RELATED APPLICATION

The present application is based on Japanese Patent Application No. 2009-101938 filed on Apr. 20, 2009, the disclosure of which is incorporated herein by reference.

### FIELD OF THE INVENTION

The present invention relates to an aluminum-aluminum nitride composite material (hereinafter referred to as an Al—AlN composite material) composed of aluminum and aluminum nitride bonded thereto, a manufacturing method of the Al—AlN composite material and a heat exchanger including the Al—AlN composite material.

### BACKGROUND OF THE INVENTION

A heat exchanger is used for cooling a semiconductor module as a power converter such as an inverter, a converter or the like. In this case, the semiconductor module is configured such that an electrode plate is exposed on a surface (a heat-radiating surface). Thus, if a cooling tube of the heat exchanger is made of aluminum, in order to ensure an electrical insulation property, an insulating plate needs to be placed between the electrode plate of the semiconductor module and the cooling tube of the heat exchanger. In such a configuration, if air intervenes between the semiconductor module and the insulating plate and between the heat exchanger and the insulating plate, thermal resistance to the heat exchanger from the semiconductor module may be increased and cooling efficiency of the semiconductor module may be decreased. In order to overcome the difficulty, grease layers are arranged between the semiconductor module and the insulating plate and between the heat exchanger and the insulating plate, respectively, so that air is prevented from intervening between the semiconductor module and the insulating plate and between the heat exchanger and the insulating plate. However, if the grease layers are arranged on both surfaces of the insulating plate, thermal resistance due to the grease layers occurs at the both surfaces of the insulating plate, that is, at two areas between the semiconductor module and the insulating plate and between the heat exchanger and the insulating plate. Therefore, the increase of the thermal resistance to the heat exchanger from the semiconductor module cannot be suppressed sufficiently.

In order to overcome the difficulty, it is considered that the grease layer is arranged on only one surface of the insulating plate. For example, according to JP-A-10-287934 corresponding to U.S. Pat. No. 6,037,066, a material made by unifying a metal layer and a ceramics layer, such as a functionally gradient material, is arranged between the semiconductor module and the heat exchanger, for example. Accordingly, the increase of the thermal resistance to the heat exchanger from the semiconductor module is suppressed with the electrical insulation property between the semiconductor module and the heat exchanger ensured.

However, in the method using the functionally gradient material described in JP-A-10-287934, aluminum nitride (AlN) powder (particle) is used and the aluminum nitride power is sintered at high temperature equal to or higher than 1900° C. Thus, the temperature needs to be increased higher than 1900° C. and density of the aluminum nitride may be lowered.

### SUMMARY OF THE INVENTION

In view of the above points, it is an object of the present invention to provide an Al—AlN composite material, a manufacturing method of the Al—AlN composite material and a heat exchanger including the Al—AlN composite material. The Al—AlN composite material can be formed at low temperature and includes high-density aluminum nitride. Further, when the Al—AlN composite material is arranged between a heating element such as a semiconductor module and a heat exchanger, an increase of thermal resistance to the heat exchanger from the heating element can be suppressed with an electrical insulation property between the heating element and the heat exchanger ensured.

According to a first aspect of the present invention, an Al—AlN composite material includes one aluminum layer and an aluminum nitride layer which is directly formed on a surface of the one aluminum layer by heating a molten aluminum in a range of 900° C. to 1300° C. under a nitrogen atmosphere using a metal as an auxiliary agent so that the aluminum nitride layer is bonded to the surface of the one aluminum layer.

According to the configuration, the molten aluminum is heated in the range of 900° C. to 1300° C. under the nitrogen atmosphere using the metal as the auxiliary agent to form the aluminum nitride layer directly on the one aluminum layer. That is, a surface of the one aluminum layer is nitrided by nitrogen gas to bond the aluminum nitride layer to the one aluminum layer. Because aluminum nitride power needs not to be sintered at high temperature equal to or higher than 1900° C. unlike the conventional method, the Al—AlN composite material can be formed at low temperature in the range of 900° C. to 1300° C. compared with the high temperature equal to or higher than 1900° C., and thereby the high-density aluminum nitride layer can be obtained. Further, by arranging the Al—AlN composite material between a heating element such as a semiconductor module and a heat exchanger, electrical insulation property between the heating element and the heat exchanger can be ensured by the aluminum nitride layer. Moreover, because the aluminum nitride layer is directly bonded to the one aluminum layer, thermal resistance between the one aluminum layer and the aluminum nitride layer, can be suppressed, and an increase of thermal resistance to the heat exchanger from the heating element can be suppressed.

According to a second aspect of the present invention, a manufacturing method of an Al—AlN composite material includes pre-heating an aluminum to be in a molten state, and further heating the molten aluminum in a range of 900° C. to 1300° C. under a nitrogen atmosphere using a metal as an auxiliary agent to form an aluminum nitride layer directly on a surface of one aluminum layer and bond the aluminum nitride layer to the surface of the one aluminum layer.

According to the configuration, the molten aluminum is heated in the range of 900° C. to 1300° C. under the nitrogen atmosphere using the metal as the auxiliary agent to form the aluminum nitride layer directly on the one aluminum layer. That is, a surface of the one aluminum layer is nitrided by nitrogen gas to bond the aluminum nitride layer to the one aluminum layer. Thus, the Al—AlN composite material can be formed at low temperature and the high-density aluminum nitride layer can be obtained. Further, by arranging the Al—AlN composite material formed in this manner between a heating element such as a semiconductor module and a heat exchanger, electrical insulation property between the heating element and the heat exchanger can be ensured by the aluminum nitride layer. Moreover, because the aluminum nitride layer is directly bonded to the one aluminum layer, thermal resistance between the one aluminum layer and the aluminum nitride layer can be suppressed, and an increase of thermal resistance to the heat exchanger from the heating element can be suppressed.

### BRIEF DESCRIPTION OF THE DRAWING

The above and other objects, features and advantages of the present invention will become more apparent from the following detailed description made with reference to the accompanying drawing. In the drawing:

FIGS. 1A to 1D are views showing processes for manufacturing an Al—AlN composite material according to an embodiment of the present invention;

FIG. 2 is a flow diagram showing the processes for manufacturing the Al—AlN composite material;

FIGS. 3A and 3B are a plan view and a vertical cross-sectional view showing the Al—AlN composite material;

FIGS. 4A and 4C are cross-sectional views showing a surface of aluminum nitride before and after forming aluminum;

FIGS. 4B and 4D are enlarged views showing an area IVB and an area IVD shown in FIGS. 4A and 4C, respectively; and

FIG. 5 is a vertical cross-sectional view showing a semiconductor module and a heat exchanger.

### DETAILED DESCRIPTION OF THE PREFERRED EMBODIMENTS

Hereinafter, an embodiment of the present invention will be described with reference to accompanying drawings.

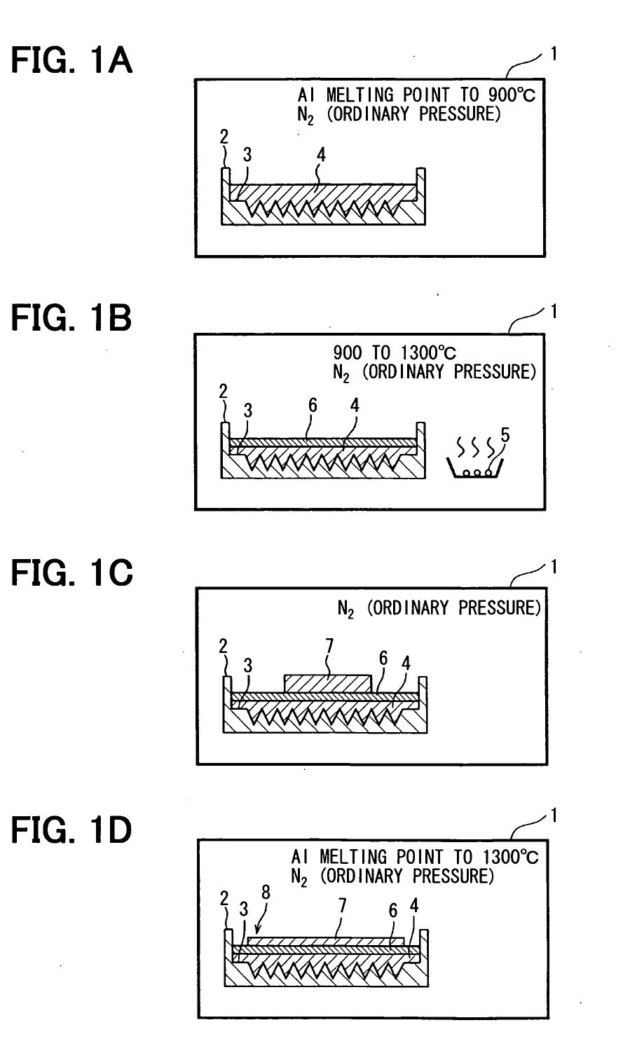

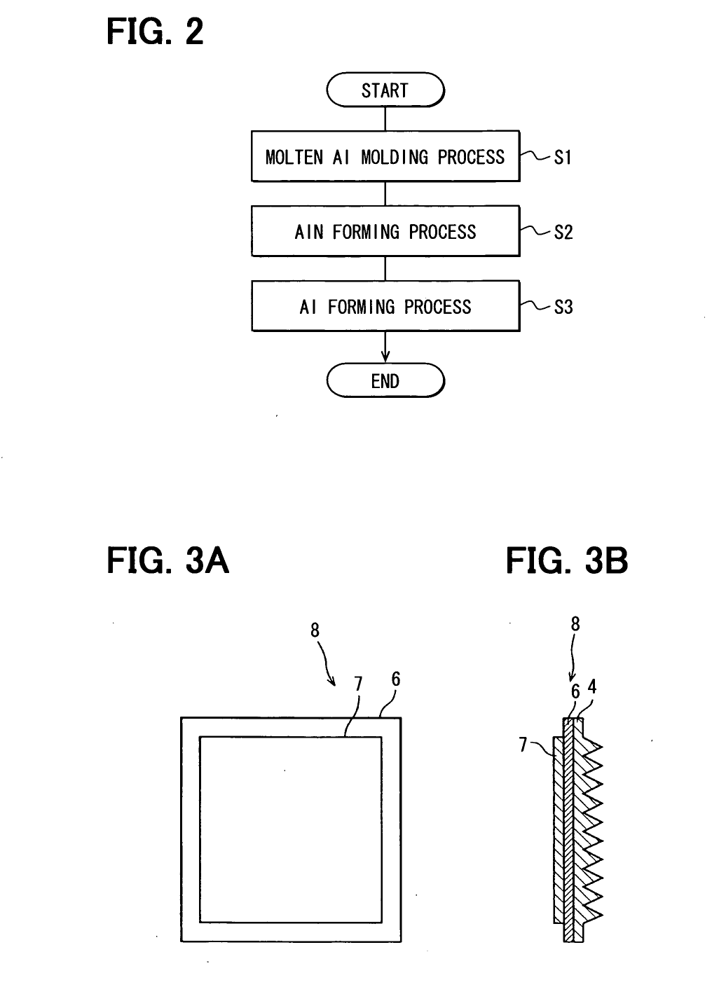

FIGS. 1A to 1D and 2 show the processes for manufacturing an Al—AlN composite material. Firstly, molten aluminum molding process for molding molten aluminum is performed at S1. As shown in FIG. 1A, solid aluminum is disposed in a cavity 3 of a mold 2 arranged in a chamber 1 of a melting furnace. The cavity 3 has many concavo-convex portions on a bottom thereof, and a top of each of the concavo-convex portions takes the form of an acute angle.

The chamber 1 is vacuumed to evacuate air containing oxygen in the chamber 1, and then, nitrogen (N₂) gas is introduced into the chamber 1, thereby forming a nitrogen atmosphere therein. The purity of the nitrogen gas introduced into the chamber 1 is 5N (99.999%) or more, for example. Inside of the chamber 1 is heated in the range of a melting point of aluminum (660° C.) to 900° C., and molten aluminum 4 is molded. A lower side of the molten aluminum 4 is formed to have many concavo-convex portions corresponding to the shape of the bottom of the cavity 3, and a top of each of the concavo-convex portions takes the form of an acute angle.

Then, an aluminum nitride forming process for forming aluminum nitride directly on the molten aluminum 4 is performed at S2. As shown in FIG. 1B, magnesium 5 used as an auxiliary agent is disposed in the chamber 1 and the inside of the chamber 1 is heated in the range of 900° C. to 1300° C. Because a boiling point of magnesium is 1090° C., the magnesium 5 disposed in the chamber 1 is vaporized. By making the vaporized magnesium 5 to function as the auxiliary agent, aluminum nitride 6 is formed directly on the molten aluminum 4, and the aluminum nitride 6 is bonded to the aluminum 4.

Then, an aluminum forming process for forming aluminum directly on the aluminum nitride 6 is performed at S3. As shown in FIG. 1C, the inside of the chamber 1 is cooled to ordinary temperature, the magnesium 5 remaining in the chamber 1 is removed, and then, solid aluminum 7 is disposed on the aluminum nitride 6. After that, as shown in FIG. 1D, the inside of the chamber 1 is heated in the range of the melting point of aluminum (660° C.) to 1300° C. to form the aluminum 7 directly on the aluminum nitride 6 and bond the aluminum 7 to the aluminum nitride 6. Then, the inside of the chamber 1 is cooled to ordinary temperature, and the manufactured material is removed from the mold 2 so that an Al—AlN composite material 8 having a three-layer structure composed of the aluminum 4 (an aluminum layer), the aluminum nitride 6 (an aluminum nitride layer) and the aluminum 7 (an aluminum layer) can be obtained, as shown in FIGS. 3A and 3B. In the present embodiment, one surface of the aluminum 4 has many concavo-convex portions (corresponding to a heat-radiating structure in the present invention), and a top of each of the concavo-convex portions takes the form of an acute angle.

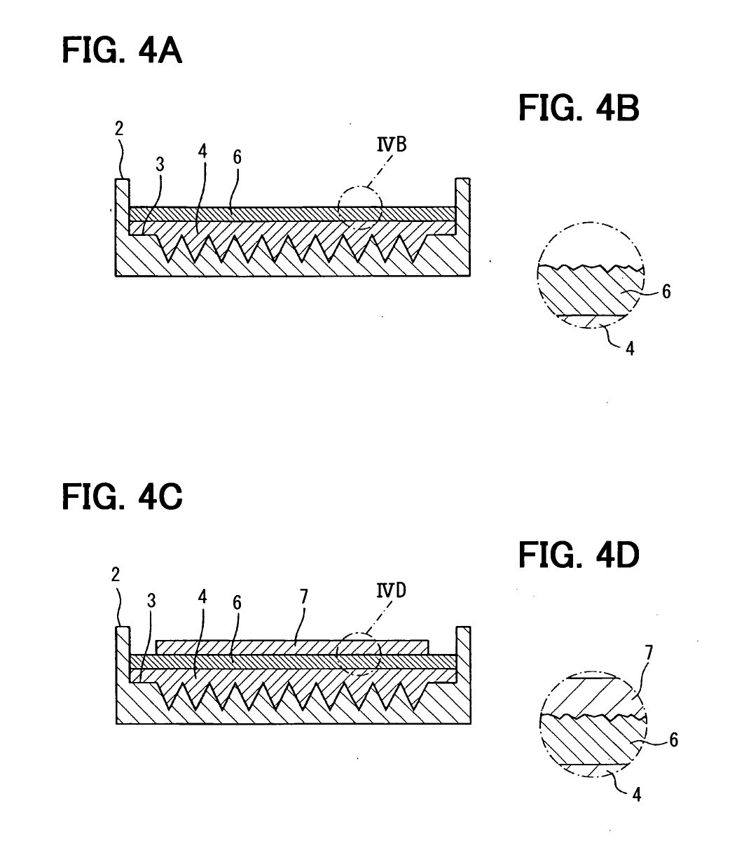

As shown in FIG. 4B, when the aluminum nitride 6 is formed on the aluminum 4, concavo-convex portions are formed on a surface of the aluminum nitride 6. However, as shown in FIG. 4D, by forming the aluminum 7 on the aluminum nitride 6, the concavo-convex portions formed on the surface of the aluminum nitride 6 can be covered by the aluminum 7. Moreover, the aluminum 7 can be used as a part of an electrode or a circuit.

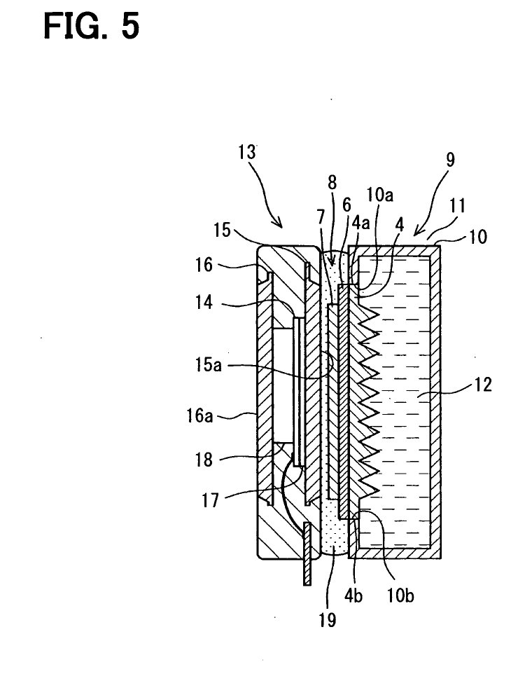

The Al—AlN composite material 8 formed in this manner is used as a part of a heat exchanger 9. As shown in FIG. 5, both end surfaces 4a, 4b of the aluminum 4 of the Al—AlN composite material 8 and both end surfaces 10a, 10b of a cooling tube member 10 made of aluminum are bonded by brazing, respectively. That is, the aluminum 4 and the cooling tube member 10 are bonded by brazing so that a cooling tube 11 is configured. The cooling tube 11 has therein a refrigerant flow passage 12 in which a cooling medium flows.

A semiconductor module 13 (corresponding to a heating element in the present invention) is a power converter such as an inverter, a converter or the like, and has therein a semiconductor element 14 such as an IGBT. The semiconductor element 14 is sandwiched between a pair of electrode plates 15, 16 made of copper via spacers 17, 18, for example. One surface 15a of the electrode plate 15 and one surface 16a of the electrode plate 16 are exposed on both surfaces of the semiconductor module 13, and the surface 15a of the electrode plate 15 adheres to the aluminum 7 of the Al—AlN composite material 8 via a grease layer 19.

According to the above-described configuration, heat generated at a side of the electrode plate 15 of the semiconductor module 13 is transferred to the Al—AlN composite material 8, and then, the heat transferred to the Al—AlN composite material 8 is transferred to the cooling medium to be heat-exchanged.

As described above, according to the present embodiment, the molten aluminum 4 is heated in the range of 900° C. to 1300° C. under the nitrogen atmosphere with the use of the magnesium 5 as the auxiliary agent to form the aluminum nitride 6 directly on the molten aluminum 4. That is, a surface of the molten aluminum 4 is nitrided by nitrogen gas to bond the aluminum nitride 6 to the aluminum 4 so that the Al—AlN composite material 8 is formed. Because aluminum nitride power needs not to be sintered at high temperature equal to or higher than 1900° C. in the present embodiment unlike the conventional method, the Al—AlN composite material 8 can be formed at low temperature in the range of 900° C. to 1300° C. compared with the high temperature equal to or higher than 1900° C., and thereby the high-density aluminum nitride 6 can be obtained. Further, by using the Al—AlN composite material 8 formed in this manner as a part of the heat exchanger 9 for cooling the semiconductor module 13, electrical insulation property between the semiconductor module 13 and the heat exchanger 9 can be ensured by the aluminum nitride 6. Further, because the aluminum nitride 6 is directly bonded to the aluminum 4, thermal resistance between the aluminum 4 and the aluminum nitride 6 can be suppressed, and an increase of thermal resistance to the heat exchanger 9 from the semiconductor module 13 can be suppressed.

Further, the molten aluminum 4 is formed to have the heat-radiating structure, that is, to have many concavo-convex portions on a surface, which is opposite to a surface on which, the aluminum nitride 6 is directly formed. Therefore, a contact area with the cooling medium can be enlarged, and the thermal resistance to the heat exchanger 9 from the semiconductor module 13 can be further suppressed.

Further, the molten aluminum 4 is heated in the range of 900° C. to 1300° C. under the nitrogen atmosphere with the use of the magnesium 5 as the auxiliary agent to form the aluminum nitride 6 directly on the molten aluminum 4, and the aluminum nitride 6 is bonded to the aluminum 4. After that, the aluminum 7 is formed directly on a surface of the aluminum nitride 6, which is opposite to a surface bonded to the aluminum 4, and the aluminum 7 is bonded to the aluminum nitride 6. Therefore, even if the concavo-convex portions are formed on the surface of the aluminum nitride 6, which is opposite to the surface bonded to the aluminum 4, the concavo-convex portions can be covered by forming the aluminum 7 directly on the aluminum nitride 6, and further, the aluminum 7 can be used as a part of an electrode or a circuit.

Moreover, the aluminum 4 of the Al—AlN composite material 8 configures a part of the cooling tube 11, and thereby the aluminum 4 directly contacts the cooling medium. Thus, heat-transfer efficiency between the Al—AlN composite material 8 and the cooling medium can be increased, and therefore, the increase of the thermal resistance to the heat exchanger 9 from the semiconductor module 13 can be further suppressed.

The present invention is not limited to the above-described embodiment, and can be modified and broadened as follows.

The present invention is not limited to forming the Al—AlN composite material 8 having the three-layer structure composed of the aluminum 4, the aluminum nitride 6 and the aluminum 7. Another Al—AlN composite material having a two-layer structure composed of the aluminum 4 and the aluminum nitride 6 may be formed without forming the aluminum 7.

The surface of the molten aluminum 4, which is opposite to the surface on which the aluminum nitride 6 is, directly formed, may not have the heat-radiating structure.

The Al—AlN composite material 8 may not be used as a part of the heat exchanger 9. The Al—AlN composite material 8 may be formed separately from the heat exchanger 9.

While the invention has been described with reference to preferred embodiments thereof, it is to be understood that the invention is not limited to the preferred embodiments and constructions. The invention is intended to cover various modification and equivalent arrangements. In addition, while the various combinations and configurations, which are preferred, other combinations and configurations, including more, less or only a single element, are also within the spirit and scope of the invention.

What is claimed is:

1. An Al—AlN composite material comprising:
one aluminum layer; and
an aluminum nitride layer which is directly formed on a surface of the one aluminum layer by heating a molten aluminum in a range of 900° C. to 1300° C. under a nitrogen atmosphere using a metal as an auxiliary agent so that the aluminum nitride layer is bonded to the surface of the one aluminum layer.

2. The Al—AlN composite material according to claim 1, wherein
magnesium is used as the auxiliary agent so that the aluminum nitride layer is bonded to the surface of the one aluminum layer.

3. The Al—AlN composite material according to claim 1, wherein
the one aluminum layer has a heat-radiating structure having a plurality of concavo-convex portions on a surface, which is opposite to the surface of the one aluminum layer.

4. The Al—AlN composite material according to claim 1, further comprising:
another aluminum layer on the aluminum nitride layer, wherein
the another aluminum layer is directly formed on a surface of the aluminum nitride layer, which is opposite to the surface of the one aluminum layer, and is bonded to the aluminum nitride layer after the aluminum nitride layer is formed directly on the one aluminum layer.

5. A manufacturing method of an Al—AlN composite material, the method comprising:
pre-heating an aluminum to be in a molten state; and
further heating the molten aluminum in a range of 900° C. to 1300° C. under a nitrogen atmosphere using a metal as an auxiliary agent to form an aluminum nitride layer directly on a surface of one aluminum layer and bond the aluminum nitride layer to the surface of the one aluminum layer.

6. The method according to claim 5, wherein
magnesium is used as the auxiliary agent to bond the aluminum nitride layer to the surface of the one aluminum layer.

7. The method according to claim 5, wherein
the one aluminum layer has a heat-radiating structure having a plurality of concavo-convex portions on a surface, which is opposite to the surface of the one aluminum layer.

8. The method according to claim 1, further comprising:
forming another aluminum layer directly on a surface of the aluminum nitride layer, which is opposite to the surface of the one aluminum layer, and bonding the another aluminum layer to the aluminum nitride layer after the aluminum nitride layer is formed directly on the one aluminum layer.

9. A heat exchanger including the Al—AlN composite material according to claim 1.

10. The heat exchanger according to claim 9, comprising:
a cooling tube having therein a refrigerant flow passage in which a cooling medium that is heat-exchanged with a heating element flows, wherein
the one aluminum layer of the Al—AlN composite material configures a part of the cooling tube.
